(19) United States
(12) Patent Application Publication
(10) Pub. No.: US 2025/0339753 A1
(43) Pub. Date: Nov. 6, 2025

(54) SYSTEM FOR EXERCISE MACHINES

(71) Applicant: JOHNSON HEALTH TECH CO., LTD, Taichung City (TW)

(72) Inventors: Nathan Pyles, Lake Mills, WI (US); Andrew Klossner, Columbus, WI (US); Jill Woodward, Waunakee, WI (US)

(21) Appl. No.: 18/654,868

(22) Filed: May 3, 2024

(51) Int. Cl. A63B 71/06; A63B 24/00; H04N 21/258; H04N 21/2668; H04N 21/414

(52) U.S. Cl. CPC A63B 71/0622; A63B 24/0087; H04N 21/25875; H04N 21/2668; H04N 21/414; A63B 2071/0638; A63B 2225/15; A63B 2225/20

(57) ABSTRACT

A device may include a file server configured to store and manage media files within a database, each media file of the media files including one or more of video content, audio content, and an image representative of the media file, the file server further configured to control an online portal in communication with the database through a computer network for access by a user device to display at least one of the media files from the database via a display. The file server is configured to receive screening data related to the exercise machine, access the media files stored in the database, determine a recommended media file at least in part based on the screening data, and communicate at least a portion of the recommended media file to the user device through the online portal, and wherein the user device is configured to execute the recommended media file.

The present invention relates to exercise machines. More particularly, the present invention relates to a media file delivery system for exercise machines.

### BACKGROUND

Connected fitness experiences, where a streamed fitness video (Video-On-Demand/VOD) is integrated with a LCD console on an exercise machine (such as treadmills, stationary bikes, or elliptical machines), have become increasingly popular for home fitness market. The content of the aforementioned video may be an exercise class in which an instructor uses an exercise machine and verbally guides people to simulate his movements, or it may be a pre-recorded video, similar to following an instructor for running or hiking outdoors, or simply a forward-motion video of outdoor reality without an instructor, such as Virtual Active (VA) experiences, which is a first-person, forward-motion video experience designed to enhance the cardio workout. The system may include exercise machine manufacturers, media content providers, fitness facility managers, and end consumers or exercise machine users.

The typical operation is described as follows: A qualified exercise machine includes a video display device and an audio display device, which can form a data transmission connection with a specific file server through a computer network so that the user can browse the thumbnails and basic information of the media files provided by the file server through a file display screen on the video display device. When the user selects one media file to be executed, the file server will transmit the video data of the selected media file to the exercise machine in a streaming manner. At the same time, the exercise machine will immediately play the continuously received video data in the form of streaming media until it ends or pauses. This is similar to the “video on demand (VOD)” service provided by current streaming media providers such as Netflix, which enables users to select and watch different video content instantly through their TV or computer.

In general, the execution of streaming media, especially high-definition videos, requires meeting both specific software and hardware requirements on the playback end, as well as a suitable network data transmission environment. In other words, if the maximum bandwidth of the downlink channel from the computer network to the exercise machine is insufficient, or even if the bandwidth is large enough, the actual data transmission rate is reduced or unstable due to network problems such as peak hours of network traffic, the playback of the streaming media may experience stops, lags, poor buffering of the content, or poor resolution, which may seriously affect the user experiences. Therefore, to satisfy dozens or hundreds of people using respective exercise machines to watch different streaming media, the fitness clubs or community sports centers must spend money to prepare a high-quality network data transmission environment including an external network and an internal network, and continue to pay high network usage fees to the Internet service providers (ISPs) and so on. Even so, when the computer network gets stuck abnormally or the file server is fully loaded, the playback of the streaming media on the respective exercise machines in the fitness facilities may still experience stops or logs.

Media content providers may launch new videos for various exercise machines regularly or irregularly. However, before the next video update (it may be weeks to months), the content of the file display screen on the exercise machine is usually unchanged and lacks freshness, which may cause users to gradually pay less attention and lose interest in using.

The present invention has arisen to mitigate and/or obviate the disadvantages of the conventional method. Further benefits and advantages of the present invention will become apparent after a careful reading of the detailed description with appropriate reference to the accompanying drawings.

### SUMMARY OF THE INVENTION

The present invention is directed to exercise machines and a media file delivery system for exercise machines, which provides media files on demand for exercise machine users. In addition, for a better user experience, each exercise machine has a QR code attached to it, allowing users to easily access the media files associated with the corresponding exercise machine.

The QR code technology can be used to eliminate multiple steps for accessing the media files. Therefore, the user can use their user device to obtain workout information or correlated video content by scanning the QR code on the exercise machine that they are ready to use.

In some aspects, the techniques described herein relate to a system for an exercise machine, the system including: a file server configured to store and manage media files within a database, each media file of the media files including one or more of video content, audio content, and an image representative of the media file, the file server further configured to control an online portal in communication with the database through a computer network; an exercise machine including a motion mechanism engageable or operable by a user to perform one or more physical exercises; an identifier associated with the exercise machine and including a connection to the online portal to facilitate user access to the media files; and a user device including a display, an image capture device, and a processor including instructions configured to communicate with the online portal by scanning the identifier via the image capture device for user access to the file server, the processor instructions further configured to control the display to illustrate the image representative of the media file, the user device configured to display at least one of the media files from the database via the display, wherein the file server is configured to: receive, via the user device through the online portal, screening data related to the exercise machine, access the media files stored in the database via the computer network, determine a recommended media file from the media files at least in part based on the screening data, and communicate at least a portion of the recommended media file to the user device through the online portal, and wherein the user device is configured to execute the recommended media file.

In some aspects, the techniques described herein relate to a system, wherein the user device includes an electronic device portable by the user, and the identifier is optically detectable by the image capture device for user identification so that the user is eligible to access the online portal to retrieve the recommended media file provided by the file server.

In some aspects, the techniques described herein relate to a system, wherein the identifier includes a machine-readable code on the exercise machine having a static or dynamic quick response (QR) code or bar code that is specific to one type of exercise machine that is used by the user so that the user can see the recommended media file that is relevant to the one type of exercise machine.

In some aspects, the techniques described herein relate to a system, wherein the recommended media file is randomly selected from the media files stored in the file server based in part on whether the recommended media file has been previously selected.

In some aspects, the techniques described herein relate to a system, wherein the processor includes instructions configured to request the file server provide data related to the recommended media file through the computer network, and wherein when the user scans the identifier on the exercise machine and executes the recommended media file on the online portal, the file server transmits the data of the recommended media file to the user device through the computer network in a streaming manner according to a request from the processor, and the processor controls the display to display the video content or the audio content, or both, of the recommended media file associated with the exercise machine.

In some aspects, the techniques described herein relate to a system, wherein the online portal facilitates access by the user to the recommended media file or access to one or more workout programs.

In some aspects, the techniques described herein relate to a system, wherein the online portal is controlled by the file server to display a specific quantity of categories for the user to choose from, and wherein one of the categories is associated with an instructor-led class in which an instructor guides users to simulate their movements.

In some aspects, the techniques described herein relate to a system, wherein the online portal is controlled by the file server to display a first category of the media files associated with an instructor-led class in which an instructor guides users to simulate their movements, a second category of media files associated with a pre-recorded video as a forward-motion video of outdoor reality, and a third category of media files associated with a workout program.

In some aspects, the techniques described herein relate to a system for exercise machines, the system including: a file server configured to store and manage a plurality of media files, each media file of the plurality of media files including one or more of video content, audio content, and an image representative of the media file; a plurality of exercise machines, each having a motion mechanism operable by a user to perform physical exercises, each exercise machine having an identifier accessible to the user, the identifier provided to allow the user to link to an online portal that permits access by the user to the media files stored in the file server through a computer network, wherein the online portal is controlled by the file server to show an image representative of a recommended media file, the recommended media file selected from the media files stored in the file server and updated every day; and a user device including a display, an image capture device, and a processor, the user device operable to connect to the online portal by scanning the identifier through the image capture device, the processor including executable instructions to control the display to display the online portal that shows the image representative of the recommended media file; wherein the file server delivers a programmed workout to manage the recommended media files for two or more exercise machines of the plurality of exercise machines so that the user has access to the recommended media files through the user device from different exercise machines in sequence for the programmed workout.

In some aspects, the techniques described herein relate to a system, wherein the user device includes an electronic device portable by the user, and the identifier of each exercise machine of the plurality of exercise machines is optically detectable by the user device for user identification so that the user is eligible to access the online portal and the recommended media file provided by the file server.

In some aspects, the techniques described herein relate to a system, wherein the identifier of each exercise machine includes a machine-readable code having a static or dynamic quick response (QR) code or bar code specific to one type of exercise machine such that the user can see the recommended media file corresponding with the type of exercise machine.

In some aspects, the techniques described herein relate to a system, wherein the recommended media file is randomly selected from the media files stored in the file server based in part on whether the recommended media file has been previously selected.

In some aspects, the techniques described herein relate to a system, wherein the processor of the user device includes instructions to request the file server to provide data of the recommended media file through the computer network, and wherein when the user scans the identifier on the exercise machine and executes the recommended media file on the online portal, the file server transmits the data of the recommended media file to the user device through the computer network in a streaming manner according to the request of the processor, and wherein the processor will control the display device to display the video file of the recommended media file associated with the exercise machine.

In some aspects, the techniques described herein relate to a system, wherein the online portal is controlled by the file server to display a specific quantity of categories for the user to choose from, and wherein one of the categories is associated with an instructor-led class in which an instructor guides users to simulate their movements.

In some aspects, the techniques described herein relate to a system, wherein the online portal is controlled by the file server to display a first category of the media files associated with an instructor-led class in which an instructor guides users to simulate their movements, a second category of media files associated with a pre-recorded video as a forward-motion video of outdoor reality, and a third category of media files associated with a workout program.

In some aspects, the techniques described herein relate to a method of using an exercise machine, the method including: providing at least one file server to store and manage a plurality of media files within a database, each media file including video content, audio content, and an image representative of the media file, the file server configured to control one or more online portals in communication with the database; providing an identifier associated with an exercise machine, the identifier scannable by a user through a user device; accessing an online portal of the one or more online portals via a user device by scanning the identifier through an image capture device of the user device and displaying the online portal on a display of the user device, accessing the plurality of media files stored in the database; determining a recommended media file from the file server based on the identifier, the recommended media file selected from the media files stored in the file server and updated every day; communicating an image representative of the recommended media file through one online portal of the one or more portals to the display of the user device; accessing the recommended media file from the file server in response to the user instructing the file server to execute the recommended media file displayed on the one online portal; and communicating the recommended media file, including the video content, the audio content, or both, through the one online portal to the user device.

In some aspects, the techniques described herein relate to a method, wherein the user device includes an electronic device portable by the user, and the identifier is optically detectable by the user device for user identification so that the user is eligible to login to the one online portal to access the recommended media file delivered by the file server.

In some aspects, the techniques described herein relate to a method, wherein the identifier includes a machine-readable code on the exercise machine defined by a static or dynamic quick response (QR) code or a bar code specific to one type of exercise machine that is usable by the user so that the user can see the recommended media file that is relevant to the one type of exercise machine.

In some aspects, the techniques described herein relate to a method, wherein the recommended media file is randomly selected from the media files stored in the file server based in part on whether the recommended media file has been previously selected.

In some aspects, the techniques described herein relate to a method, wherein the online portal is controlled by the file server to display a first category of the media files associated with an instructor-led class in which an instructor guides users to simulate their movements, a second category of media files associated with a pre-recorded video as a forward-motion video of outdoor reality, and a third category of media files associated with a workout program.

Preferably, the user device is an electronic device portable by the user, and the identifier is optically detectable by the user device for user identification, so that the user is eligible to log in to the online portal to access the recommended media file provided by the file server.

Preferably, the identifier is a machine-readable code on the exercise machine, including a static or dynamic quick response (QR) code or bar code, which is specific to one type of exercise machines that is used by the user so that the user can see the recommended media file that is relevant to the exercise machine.

Preferably, the recommended media file is randomly selected from the media files stored in the file server, and the recommended media file is preferentially selected from the media files that have never been selected, for example, by the file server or a particular user.

Preferably, the processor of the user device is operable to request the file server to provide data of the recommended media file through the computer network. When the user scans the identifier on the exercise machine and executes the recommended media file on the online portal, the file server will transmit the data of the recommended media file to the user device through the computer network in a streaming manner according to the request of the processor, and the processor will control the display device to display the video content of the recommended media file associated with the exercise machine.

Preferably, the online portal is controlled to display three categories for the user to choose from, including one category associated with an instructor-led class in which an instructor guides users to simulate their movements, another category associated with a pre-recorded video as a forward-motion video of outdoor reality, and the other category associated with a workout program.

Further benefits and advantages of the system will become apparent after a careful reading of the detailed description with appropriate reference to the accompanying drawings.

### BRIEF DESCRIPTION OF DRAWINGS

FIG. 1 is a diagram of an exemplary media file distribution or delivery system for exercise machines.

FIG. 2 is a schematic diagram illustrating the configuration of an exercise machine including an exemplary media file distribution system.

FIG. 3 illustrates the configuration of a media file of the media file distribution system.

FIG. 4 illustrates an example file display screen of an exemplary media file.

FIG. 5 illustrates that the recommended media file is updated regularly.

FIG. 6 illustrates an example of a file distribution plan for the media file distribution system.

FIG. 7 is a diagram of another exemplary media file distribution or delivery system for exercise machines.

FIG. 8 illustrates a user device that a user can access to link to an online portal by scanning a QR code on the exercise machine for accessing a recommended media file.

FIG. 9 is a block diagram illustrating the configuration of the user device shown in FIG. 8.

FIG. 10 illustrates the online portal including three categories of video for the user to choose from.

FIG. 11 illustrates the system providing a programmed workout to manage the recommended media files for exercise machines in a workout place so that the user has access to the recommended media files through the user device from different exercise machines in sequence for the programmed workout.

### DETAILED DESCRIPTION

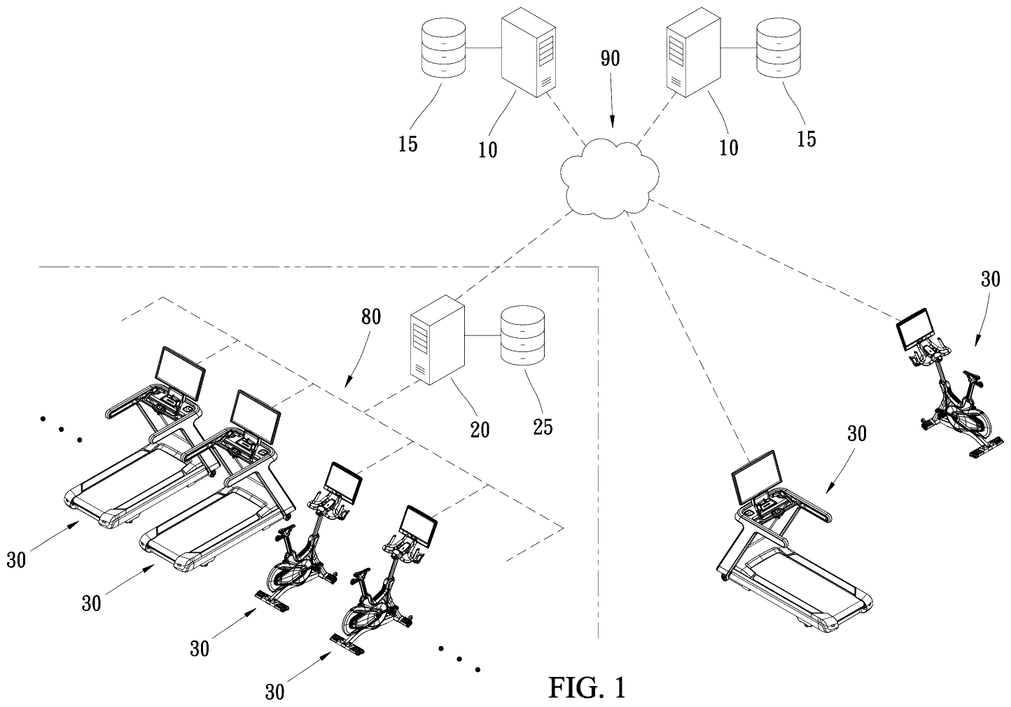

FIG. 1 illustrates one non-limiting example of a media file distribution system for exercise machines (e.g., for use by a user for physical exercise). The media file distribution system includes at least one remote server 10 and a plurality of exercise machines 30 that communicate with the remote server 10 through a computer network to form a data transmission connection therebetween. The exercise machines 30 may be distributed in various locations across the computer network coverage. The computer network includes a wide area network 90, so the exercise machines 30 may be distributed in multiple locations in different communities, different cities, or even different countries. Some exercise machines 30 may be located in the home of an individual user (as shown on the right side of FIG. 1), and some exercise machines 30 may be centrally located in a workout place or workout facility such as a health club, fitness club, fitness center, or commonly referred to as a gym (as shown on the left side of FIG. 1). For the entire system, such exercise machines 30 may include various types of exercise machines, such as treadmills, stationary bikes (including upright bikes, recumbent bikes, flywheels), elliptical machines, steppers, stair machines and rowing machines, and the same type of exercise machines may also include different species, as long as each of the exercise machines 30 has respectively required hardware, software, and service authorization of the remote server 10 for data transmission. The authorization may be attached to the exercise machine 30, or to the user of the exercise machine 30.

The remote server 10 is connected to the wide area network 90, which can access and manage data or files in a remote database 15, including a plurality of media files with video content. The media files are provided by media content providers, uploaded to the remote server 10 via the wide area network and stored in the remote database. The media file distribution system includes a plurality of remote servers 10 and remote database 15, which can be used to distribute the service load. For example, different types of exercise machines will be connected to different remote servers 10 to obtain corresponding media files. In terms of main functions, each of the remote servers 10 is substantially a file server. The term “remote” refers to the location relative to the exercise machines 30, namely the remote servers 10 and the exercise machines 30 are usually not in the same place.

The workout place may have a local server 20, and the exercise machines 30 within the workout place are able to communicate with the local server 20 through a local area network 80 (e.g. Ethernet or Wi-Fi) to form a data transmission connection to accept management and services of the local server 20. Besides, the local server 20 can connect to an external network (i.e. the wide area network 90) and has routing functions, so that the exercise machines 30 within the workout place can request data of the media files from the remote server 10 through the local server 20 and receive the data of the media files from the remote server 10. Therefore, for the exercise machines 30 installed in the workout place, the computer network includes the local area network 80 and the wide area network 90. On the other hand, as shown in the right side of FIG. 1, each exercise machine 30 of the individual user may directly connect to the wide area network 90 or connect to the wide area network 90 through a local area network such as a community network.

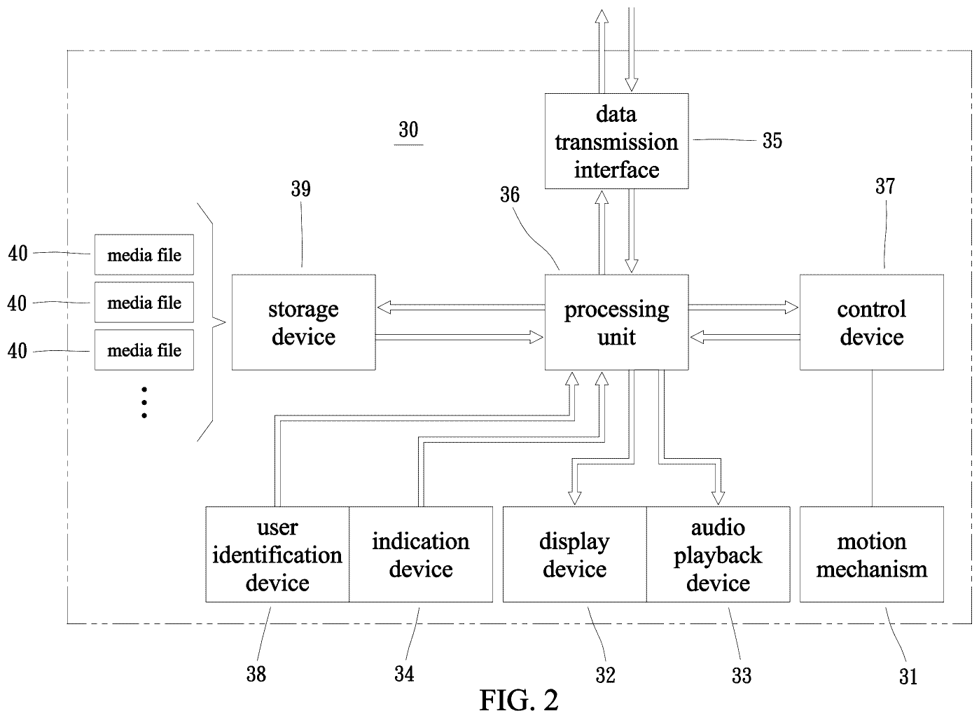

Referring to FIG. 2, each exercise machine 30 has a motion mechanism 31, a display device 32, an audio playback device 33, an indication device 34, a data transmission interface 35 and a processor 36. The motion mechanism 31 is provided for allowing a user to perform an exercise, such as a running belt for treadmills, pedals for stationary bikes, and so on. As shown in FIG. 1, the display device 32 can display images to the user. As shown, each exercise machine 30 includes a flat panel display (including touch screen) at the front of each exercise machine 30. The audio playback device 33, such as a speaker integrated into the flat panel display, can play sounds to the user. The indication device 34, such as the touch screen or various physical buttons, allows the user to input instructions or commands. The data transmission interface 35, such as a wired or wireless network interface, is able to communicate with the remote server 10 (and the local server 20) through the computer network to form a data transmission connection therebetween. The processor 36 is electrically connected to the display device 32, the audio playback device 33, the indication device 34, and the data transmission interface 35, is capable of processing executable instructions received by the indication device 34 and data received by the data transmission interface 35 and further controlling the displayed images on the display device 32 and the sound played by the audio playback device 33. The processor 36 may be a microprocessor, a central processing unit (CPU), an embedded processor, or another type of electronic processor including executable instructions (e.g., stored in a non-volatile memory) to operate and/or drive the exercise machine 30.

Each exercise machine 30 has a non-volatile storage device 39 that is configured to store a plurality of media files or folders 40. When the exercise machine 30 is first used, the storage device 39 may not have any saved media files, or the storage device 39 may only have pre-stored media files before the exercise machine 30 leaves the factory. However, based on the operation of the system of the present invention, the storage device 39 will store the media files 40 provided by the remote server 10 directly or indirectly after a period of normal usage. Unlike the temporary data stored in a register or a main memory such as dynamic random-access memory (DRAM) that assists in various tasks of the processor 36, the data stored in the storage device 39 will not be lost due to the interruption of the power supply (e.g. exercise machine 30 turned off). In practice, the storage device 39 may include solid state drives (SSDs), hard disk drives (HDDs), flash memory, or other types of memory storage. The processor 36 is electrically connected to the storage device 39 to perform data access on the storage device 39, including reading, writing, editing, moving, deleting, etc. The non-volatile storage device 39 may further include identification data corresponding to the respective exercise machine. For example, the storage device 39 may include a model number, an exercise machine type (treadmills, stationary bikes, etc.), use data of the exercise machine 30, and a media file use history.

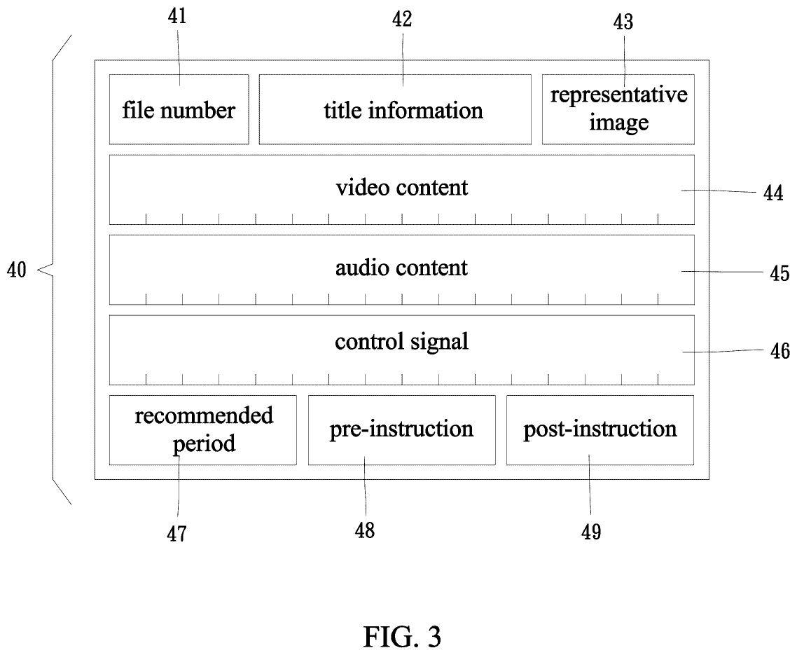

Referring to FIG. 3, each media file 40 includes data corresponding to video content 44 and data corresponding to audio content 45. Each media file 40 may include an image representative of the media file 40 (e.g., to uniquely identify the media file 40 to a user). The video content 44 and the audio content 45 include a respective video file and an audio file configured to be played concurrently. For example, the media file 40 may be or include a video recording of an exercise class led by an instructor, or a video of outdoor scenes with background music. The display device 32 of each exercise machine 30 can display the video content 44, and the audio playback device 33 can play the audio content 45 to guide the user to perform an exercise by using the motion mechanism 31 of the corresponding exercise machine 30. It should be understood that data may be conveyed in a variety of ways. For example, files, folders, and other groupings of data may be referred to interchangeably herein.

Some exercise machines 30 in the system may have an electronic control device 37 that can adjust the exercise difficulty level of the motion mechanism 31 for the user to exercise, such as the rotational speed of the running belt of a treadmill, the inclination of the treadmill platform, or the pedal resistance of a stationary bike. The processor 36 is electrically connected to the control device 37 so as to control the control device 37 to control the exercise difficulty level, and to receive feedback signals from the control device 37. For the exercise machines 30 with the control device 37, some media files 40 have data corresponding to a set of control signals 46, and these control signals 46 and the video content 44 have a timing coordination relationship. For example, the media files 40 may additionally include a timestamp file corresponding to events on the video content 44. Using the timestamp file, the control device 37 can then reference the timestamps of the video content 44 to produce the relevant control signals 46 to adjust the exercise difficulty level. The processor 36 can sequentially control the control device 37 according to the control signals 46, so that the motion mechanism 31 can provide a specific difficulty level at a specific time point of the video content. For example, when playing a video of an exercise class led by an instructor, the difficulty level of the motion mechanism 31 will automatically increase or decrease in time according to the instructor's demands in the video, or when playing a forward-motion video of outdoor scenes, the corresponding treadmill inclination or pedal resistance is adjusted based on the terrain in the video.

Each of media files 40 may further include data corresponding to a file number 41, data corresponding to title information 42, and data corresponding to a representative image 43 or a thumbnail. The file number 41 is regarded as the unique identification of each media file 40 mainly for file management. The title information 42 records brief information of each media file 40, such as the category, name, instructor, time length, and exercise difficulty, allowing users to easily identify the content of each media file 40. The representative image 43 represents the video content of each media file 40 with a representative image, for example a thumbnail. In some examples, the representative image 43 may also include a carousel of multiple images or a short video that plays back in a loop. The video or carousel of images may be developed using the video content of the media file 40, another video shot, an image synthesis, a highlight edit, etc. Additionally, eye-catching text images may be added to the representative image 43 to allow users to quickly know the content of each media file 40.

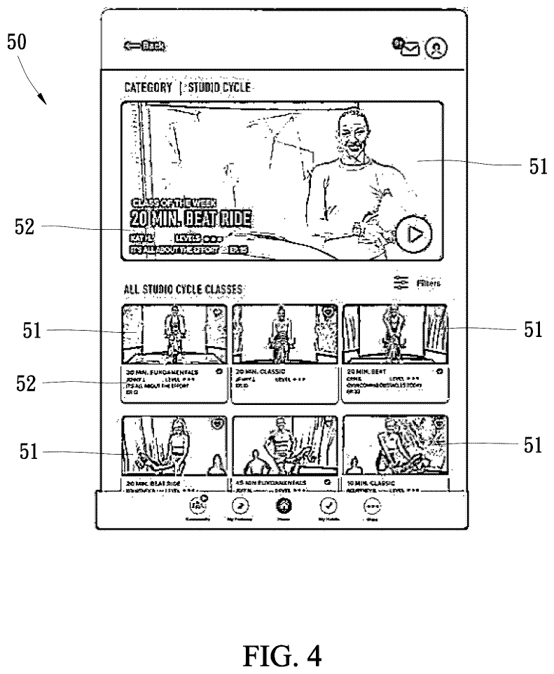

The processor 36 of each exercise machine 30 can control the display device 32 to display a file display screen on the entire screen or part of it. The file display screen is designed to display representative images of the media files 40 that can be selected and executed by the user, which allows them to intuitively search for video content that meets their personal needs and can be specified for execution after further confirmation. The file display screen may show up in response to the user's instructions through the indication device 34, or it may show up automatically when the exercise machine 30 is not in use. FIG. 4 illustrates a file display screen 50 that displays a representative image 51 of a current recommended media file that is highlighted on the file display screen. For example, once the display device 32 is switched to the file display screen 50, the upper half of the display screen 50 will show the representative image 51 of the recommended media file separately, and the lower half of the display screen will display several representative images 51 of other media files at the same time. As shown in FIG. 4, the representative image 51 of the recommended media file is significantly larger than the representative images 51 of other media files. For example, the width and height of the representative image 51 in the upper half of the file display screen 50 are twice longer than those of the representative images 51 in the lower half, which is equivalent to an area of at least four times as big. In this way, when users see the file display screen 50, they will naturally focus on the representative image 51 of the recommended media file first. Preferably, the representative image 51 of the recommended media file may be presented in a dynamic manner, such as a carousel of multiple images or a short video that plays back in a loop, while the representative images 51 of other media files may be presented in static manner, such as continuously displaying the same image or stationary image before video playback.

On the other hand, as shown in FIG. 4, the corresponding title information 52 of the recommended media file is displayed in an appropriate corner of the corresponding representative image 51, and the corresponding title information 52 of other media files is displayed below their representative images. For example, the title information of the recommended media file may be displayed at larger (e.g., twice) font size than the title information of the other media files. In addition, the representative image 51 of the recommended media file include additional markings or labels, such as a “CLASS OF THE WEEK” banner, to further differentiate the recommended media file. In addition, when one of the media files 40 is chosen as the recommended media file, the image form or image content of the representative images 51 presented on the file display screen 50 may change. The processor 36 may change the pictures or videos based on at least one of: a predetermined rule, controlled image carousel or video playback, enlarge/reduce image size, superimpose text, and so on.

In general, the number of the media files 40 that can be selected by users may be as many as dozens or even hundreds. It is conceivable that the file display screen 50 generally cannot show all the representative images 51 and the title information 52 of all the media files 40 within one screen range simultaneously. Therefore, the interface design usually allows the display content of at least part of the file display screen 50 to be scrolled or page changed based on the user's operation, so that more representative images 51 and/or the title information 52 of the media files 40 can be displayed sequentially. The display device 32 utilizes a touch screen, allowing the user to slide their fingers vertically on the screen to scroll up and down the display content in the lower half of the file display screen 50 to browse more representative images 51 of the media files 40, while the representative image 51 of the recommended media file in the upper half of the screen remain unmoved. In another method, all the representative images on the file display screen 50 will scroll up and down together. In other words, the representative image 51 of the recommended media file that is initially displayed in the upper half of the screen may also be temporarily moved out of the screen by the operation of the user.

In addition to sequentially browsing representative images of all media files 40 that can be selected for execution, the user can also limit the number of the media files 40 through screening functions, such as specifying the length of exercise classes, the type of exercise machine, and exercise difficulty levels. Said another way, the media files 40 may further include screening data used to sort and identify specific media files 40 displayed, searched, sorted, or referenced. The screening data may include the video duration, an instructor name, a specific type of exercise machine, a video category (e.g., instructor led), etc. The screening data may accordingly be used by the screening functions to allow the user to filter through a subset of the media files 40. It should be noted that the screen composition of the file display screen 50 and the operation methods are only shown for illustration and are not limited in the present invention. Of course, it is possible to use different interface designs for execution. For example, the file display screen may display the representative image of the recommended media file alone until the user instructs to browse other media files. Specifically, the position of the representative image of the recommended media file on the file display screen can be compared to the so-called “Hero section” in today's online portal design, which is the area that users will focus on when they see this screen.

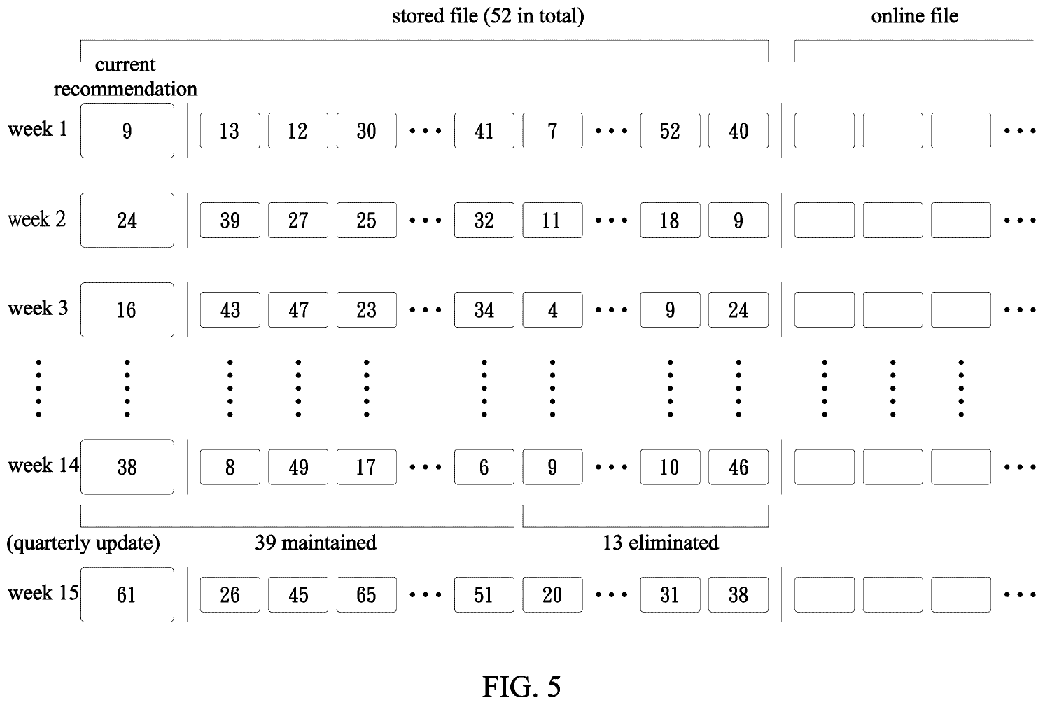

The recommended media file is selected from the media files 40 stored in the storage device 39 in a predetermined manner, and is updated regularly (e.g., once a week or every day). In one non-limiting example, the method of selecting the recommended media file from the media files 40 stored in the storage device 39 includes random selection, and the media files that have never been randomly selected (e.g., by the file server 10 or by a user) may be given priority over the media files that have been selected when the recommended media file is randomly selected. Referring to FIG. 5, assuming that the recommended media file is updated once per week, and the storage device 39 stores 52 different media files 40, each called file No.1 to No.52. On the first day of the first week, the processor 36 randomly selects file No.9 from the fifty-two media files as the recommended media file for this period (this week). One week later, on the first day of the second week, the recommended media file will be re-selected, and file No.9 will be excluded and randomly selected from the remaining 51 media files. For example, file No.24 will be selected. Similarly, to the previous two weeks, file No.9 and file No.24 will be excluded when re-selecting in the third week and the remaining 50 media files will be randomly selected, and so on. If the storage device 39 has not obtained new media files, the recommendation process will restart on the first day of the 53rd week. For example, the recommended media file may be randomly selected from the original 52 media files without exclusion.

As illustrated in FIG. 5, the upper half of the file display screen 50 shown in FIG. 4 will display the representative image of file No.9 in the first week, and in the second week the file display screen 50 will be changed to display the representative image of file No.24, and so on. On the other hand, the representative images 51 of the other 51 media files can be displayed in order in the lower half of the file display screen 50. For example, the initial 6 of the 51 media files will be shown, and the user can scroll to browse them all. Moreover, the arrange sequence of the representative images 51 will be changed regularly, for example, once a week or every day. As illustrated in FIG. 5, in the first week, the processor 36 randomly arranges the representative images of the 51 media files except file No.9; in the second week, the representative image of file No.9 is moved to the last, while the representative images of the remaining 50 media files are randomly arranged; in the third week, the representative image of file No.24 is moved to the last, and the representative image of file No.9 is moved to the second to the last, while the representative images of the other 49 media files are randomly arranged, and so on. Briefly, the representative images of the media files that have been recommended will be ranked lower, and the more recently viewed they are, the lower they will be ranked. Likewise, the representative images of the media files that have never been recommended will be arranged higher so that the user can see them more easily.

In one non-limiting example, the media files 40 stored in the storage device 39 of each exercise machine 30 may be fully or partially updated regularly. Specifically, the remote server 10 or the local server 20 may transmit data of a scheduled media file 40 to the data transmission interface 35 of a scheduled exercise machine 30 through the computer network (wide area network 90 and/or local area network 80) at a scheduled time according to a file distribution plan. The processor 36 of each exercise machine 30 may be operable to write the data of the media file 40 received by the data transmission interface 35 into the storage device 39 to supplement or replace the media files 40 stored in the storage device 39.

Referring to FIG. 5, the 52 media files stored in the storage device 39 are enough to replace different recommended media files every week without update for a year. However, to provide sustainable services, these 52 media files can be updated remotely on a monthly, quarterly, or annual rotation. For example, in the default operation mode, the media files 40 stored in the storage device 39, “stored files” for short, are updated approximately every three months (quarterly update). The media files 40 will be replaced by a quarter each time, which means 13 of the 52 existing media files will be eliminated and 13 new media files will be added. For example, in the 14th week, 13 media files including file No.9 and file No.24 that have been recommended in the previous 13 weeks will be eliminated, and another 13 media files, file No.53 to file No.65, will be added. It is conceivable that 13 new media files from file No.66 to file No.78 will be obtained in the 27th week, replacing the 13 old media files that have been recommended between the 14th and 26th weeks for instance, and so on. The above number of media files and update frequency are just an example for illustration. Of course, there are various update methods that can be used. For example, the media files 40 may be updated every one or two weeks, and only a few media files are added or replaced each time; or the media files 40 may be updated every six months or every year, and the media files may be significantly updated or completely renewed. In some examples, the media files may be updated irregularly (e.g., portions or all of the media files may be updated, or the media files may be updated at random intervals of time). The updated amount or proportion is not restricted. If the capacity of the storage device 39 allows, new media files may be added without deleting any old media files. Especially for home exercise machines, users can specify their personal favorite media files 40 through the file display screen 50, ensuring that the specified files will not be deleted from the storage device 39 during the next update. Preferably, it can be stored in a reserved space in the storage device 39 and can be quickly selected through the screening functions.

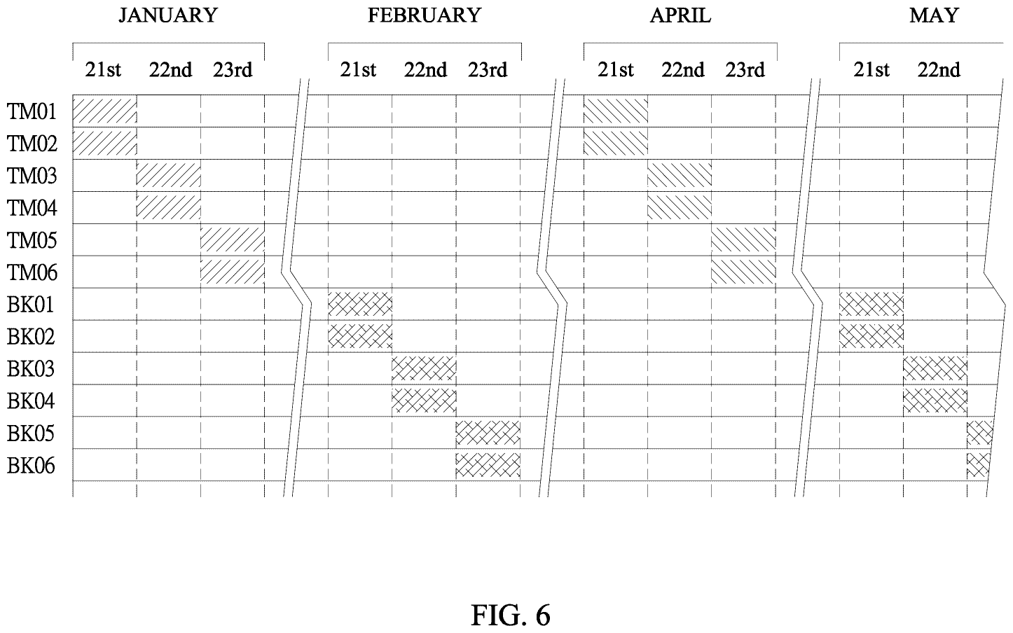

FIG. 6 illustrates a file distribution plan (part). The remote server 10 or the local server 20 is programmed to transmit the data of the media files 40 to a plurality of exercise machines 30 in a workout place according to the file distribution plan, so that the media files stored in the storage device 39 of each exercise machine 30 can be updated regularly. As shown in FIG. 6, the stored files of first-type exercise machines (such as treadmills, code TM01, TM02, etc.) in the workout place are scheduled to be updated quarterly in January, April, July and October every year; the stored files of second-type exercise machines (such as stationary bikes, code BK01, BK02, etc.) in the workout place are scheduled to be updated quarterly in February, May, August and November every year, and so on. In consideration of the possible number of exercise machines, data transmission speed, and media file updated speed, the updating operation of various types of exercise machines may be spread over several days. For example, it is scheduled to update machine No.1 and machine No.2 on the first day, and update machine No.3 and machine No.4 on the second day, and so on. Or it may be updated randomly every day depending on the situation. In short, the data of the media files 40 will be transmitted to only a specific number of exercise machines 30 in the workout place every day until all scheduled exercise machines 30 have saved all scheduled media files 40. Therefore, the stored files of each exercise machine 30 can be updated approximately every three months. Based on the same concept, the remote server 10 can transmit data of a scheduled media file 40 to an exercise machine 30 of an individual user at a scheduled time, so that the stored files of the exercise machine 30 of each of individual users can be updated regularly or irregularly.

To effectively use network bandwidth and avoid network congestion, the time that the remote server 10 or the local server 20 transmits the data of the media files 40 to the exercise machines 30 via the computer network is best scheduled during off-peak hours of network traffic in the located network environment. For example, assuming that most of the users of the workout place are concentrated in the evening hours on weekdays and weekends to use the exercise machines 30, the network traffic during these periods is significantly higher than other periods (the former is called peak hours, and the latter is called off-peak hours). In contrast, the network traffic between late night and early morning in weekdays is significantly lower. Therefore, it is suitable to schedule the transmission of the data of the media files 40 to the exercise machines 30 in the workout place during the period to update stored files of each exercise machine 30.

The local server 20 in the workout place may also function as a file server, which is able to access and manage data or files in a local database 25 (regarded as part of the local server 20). The local database 25 uses non-volatile storage devices to store data or files, including most of the media files 40. The remote server 10 can transmit the data of the scheduled media file 40 to the local server 20 that has the local database 25 through the wide area network 90 at the scheduled time according to a file distribution plan. The local server 20 can write the data of the received media file 40 into a non-volatile storage device of the local database 25 to supplement or replace the media files 40 stored in the storage device. The media files 40 managed by the local server 20 (stored in the local database 25) may be the same as the media files 40 managed by the remote server 10 (stored in the remote database 15), or the media files 40 may be part of the local server 20.

If the local server 20 in the workout place does not have any storage device that can store the media files 40, the updates of the stored files of the exercise machines 30 in the workout place is generally performed by the remote server 10 transmitting the data of the scheduled media file 40 to the local server 20 through the wide area network 90 at the scheduled time according to the file distribution plan, and the aforementioned data will be transmitted to specific exercise machines 30 in the workout place through the local area network 80 by the routing function of the local server 20; or the remote server 10 directly transmits the data of the scheduled media file 40 to the exercise machines 30 in the workout place through the computer network, without going through the local server 20. If the local server 20 has a storage device that can store the media files 40, the local server 20 can transmit the data of the scheduled media file 40 to the scheduled exercise machine 30 through the local area network 80 at the scheduled time according to the file distribution plan after obtaining the updated media files 40 from the remote server 10 to update the stored files.

To provide sustainable services, the media content providers will continue to produce new media files 40 for various types of exercise machines, regularly or irregularly upload them to the remote server 10 through the wide area network 90 and store them in the remote database 15, and then transmit their copies to the local server 20 and store them in the local database 25. In other words, the file server in the system will obtain new media files 40 periodically, regardless of the remote server 10 or the local server 20. According to the file distribution plan, the file server will arrange to transmit the newly added media files 40 to the scheduled exercise machine 30, so that the media files 40 stored in each exercise machine 30 will be fully or partially updated regularly.

The processor 36 of each exercise machine 30 can request the file server to provide data of required media files 40 through the data transmission interface 35 via the computer network. For example, the user may request data of media files 40 that is not stored in the storage device 39 of one exercise machine 30 but managed by the file server, “online files” for short. The file display screen 50 of each exercise machine 30 also displays representative images 51 of the online files. Preferably, as shown in the right side of FIG. 5, the representative images 51 of the online files are arranged after the representative images of the stored files. Therefore, when the user browses the media files that can be selected for execution by scrolling or page changing, they will normally see the representative images 51 of the stored files first, and then see the representative images 51 of the online files. In general, the stored files will be the newer media files 40 launched by the media content providers, while the online files are the earlier media files 40 that may have been saved in the storage device 39 but have been deleted.

When the user of an exercise machine 30 instructs to execute one of the media files 40 displayed on the file display screen 50, and the storage device 39 of the exercise machine 30 stores the indicated media file 40 (in other words, the user instructs to execute one of the stored files), the processor 36 will read the data of the instructed media file 40 from the storage device 39 to control the display device 32 to display the video content the instructed media file 40, and control the audio playback device to play the audio content of the instructed media file 40. If the storage device 39 of the exercise machine 30 does not store the instructed media file 40 (in other words, the user instructs to execute one of the online files), the remote server 10 or local server 20 will transmit the data of the instructed media file 40 to the data transmission interface 35 of the exercise machine 30 through the computer network in a streaming manner according to the request of the processor 36, and the processor 36 will control the display device 32 to display the video content of the instructed media file 40 based on the data received by the data transmission interface 35 in a streaming manner and control the audio playback device 33 to play the audio content of the instructed media file 40.

Accordingly, the media file distribution system of the present invention can provide streaming video files on demand for exercise machine users. Since the media files of the exercise machines can be programmed to be updated, and the content and arrangement of the file display screens are frequently changed, the media file options presented to the users can remain fresh, and the freshness of the media files would motivate the users to keep going. Specifically, the file display screen will use a highlighted method to induce the user to execute a current recommended media file. Based on the regular updates of the stored files and the recommended media files, the user would usually notice the media files that are newly updated. For users who regularly visit workout facilities (e.g., once or twice a week), even when the same type of exercise machines has the same stored files, the recommended files displayed on them may be different so that the users can always see new media files.

In general, the user will instruct to execute the current recommended media file, or other media files that are stored in the storage device of the exercise machine. Since the processor of each exercise machine can directly read the complete data of the media file selected by the user from its storage device, the video content of the media file can be played smoothly with consistent quality throughout without being affected by any data transmission problems on the computer network, resulting in a better user experience. In one non-limiting example, the user may also choose other media files stored in the remote server or local server for additional options. However, as mentioned above, based on the presentation method of the file display screen, users typically select the media files stored in the storage device, so the proportion of the media files by streaming through the network is relatively low. This is often the case for workout places with a high quantity of exercise machines for different users to use for physical exercise at the same time because the dispersion of network traffic reduces network bandwidth requirements, and the related equipment costs and network fees (e.g. ISP access fees, bandwidth usage fees, and Ethernet or Wi-Fi infrastructure costs) are lower.

Regarding the selection method of the recommended media files, in addition to the temporary random selection mentioned above, it may also be selected from the media files 40 stored in the storage device 39 in a predetermined order, for example, according to the production date or acquired time of each media file 40. In another example, all or some media files have their respective recommended periods 47 (e.g., “from a specific day of a specific month to another specific day of a specific month”, “N days from a specific day”, or “Nth week of a specific year”, and so on). Briefly, each of the recommended periods can correspond to a specific period, such that the media files 40 will be selected as the recommended media files during their corresponding recommended periods.

The recommended period of each media file 40 may be manually set by media content providers, or may be programmed by the remote server 10, the local server 20, or the processor 36 of each exercise machine 30. For example, the media files 40 each can assign a recommended period in order according to the acquired time, or randomly assign a recommended period to each media file 40. In short, the processor 36 may preset the order of multiple recommended media files in the future at once. The media files 40 with the recommended periods in the storage device 39 of each exercise machine 30 will be selected as the recommended media file for the corresponding recommended period.

The media files 40 with the preset recommended periods each has a pre-instruction 48 and a post-instruction 49. The pre-instruction 48 is used to determine whether the media file 40 will be displayed on the file display screen 50 before the corresponding recommended period. The post-instruction 49 is used to determine whether the media file 40 will be displayed on the file display screen 50 after the corresponding recommended period.

In another non-limiting example, the media files 40 includes at least one timely media file 40 for a specific annual event. The media content providers will set a recommended period for each timely media file 40, and such preset recommended period matches an occurrence period of the annual event. The media content providers can create video content in advance that is then to play when the messaging will resonate with users. For example, holiday themed classes could be played during the week major holidays. In addition, there are nationally known themes tied to each month. For instance, Martin Luther King referencing videos could play on MLK day. The recommended period of the media files for Thanksgiving themed classes could be set five days before Thanksgiving Day to that day. Similarly, May is Mental Health Awareness month. Instructor led classes could reference this topic during classes that are scheduled to play in May. According to the file distribution plan, the file server will transmit the timely media file 40 to the scheduled exercise machine 30 before the corresponding recommended period. For example, the media files for Thanksgiving themed classes may be recorded well in advance (e.g., July). When they are published to the exercise machines 30, they will include instructions not to be seen by the user until five days before Thanksgiving Day, and then not longer to be visible to the user after Thanksgiving Day. The timely media files stored in the storage device 39 of each exercise machine 30 will be chosen as the present recommended media file for the corresponding recommended period, but they will not be shown on the file display screen 50 outside of that period. This means that the user cannot choose to execute the timely media files at other times. The timely media files 40 will usually be deleted from the storage device 39 after their recommended period.

The media content providers may produce several timely media files 40 for the same annual event. The recommended periods of the media files 40 are consecutive to each other and cover the occurrence period of the annual event. For example, four media files 40 may be produced for Mental Health Awareness month, and their respective recommended periods last for one week and are consecutive to each other (e.g. the first week, the second week, the third week and the fourth week of May), forming a series of media files recommended sequentially for four consecutive weeks. The user may be notified of the series in the first week of May or earlier, but the user will not be able to choose to run the second week's media file in the first week, and so forth.

The exercise machine 30 may have a user identification device 38 to allow the processor 36 to recognize the identity of the user, which may be achieved by memory cards, NFC of portable devices (such as smartphones, or smart watches), password authentication, etc. The processor 36 of each exercise machine 30 may sort out media files that meet requirements of the user from the media files 40 stored in the storage device 39 based on the user's personalization data and/or instructions, and the representative images 51 of the sorted media files 40 are displayed on the file display screen 50. Similarly, the processor 36 may alternatively or additionally sort out media files stored in the storage device 39 based on the type of exercise machine. In another non-limiting example, the workout place installs a local server 20 with functions of a file server, managing a specific number of media files 40 stored in a local database 25. On the other hand, the exercise machines 30 in the workout place may not have enough storage to individually store the entirety of the media files 40 stored in the local database 25. In such an example, the processor 36 of each exercise machine 30 can request the local server 20 to provide media files 40 through the data transmission interface 35 via the local area network 80. During operation, each exercise machine may still display the representative images for the relevant media files without storing the entirety of the media files in the storage device 39 of the exercise machine. In such an example, the user may select a representative image on the file display screen 50 of the exercise machine. The processor 36 may then determine the file number of the selected representative image and request the corresponding media file 40 stored in the local database 25 from the local server 20. The local server 20 may transmit the data of the selected media file 40 to the data transmission interface 35 of the exercise machine 30 through the local area network 80 in a streaming manner according to the request of the processor 36. At the same time, the processor 36 will control the display device 32 to display the video content of the selected media file 40 based on the data received by the data transmission interface 35 in a streaming manner and control the audio playback device 33 to play the audio content of the selected media file 40.

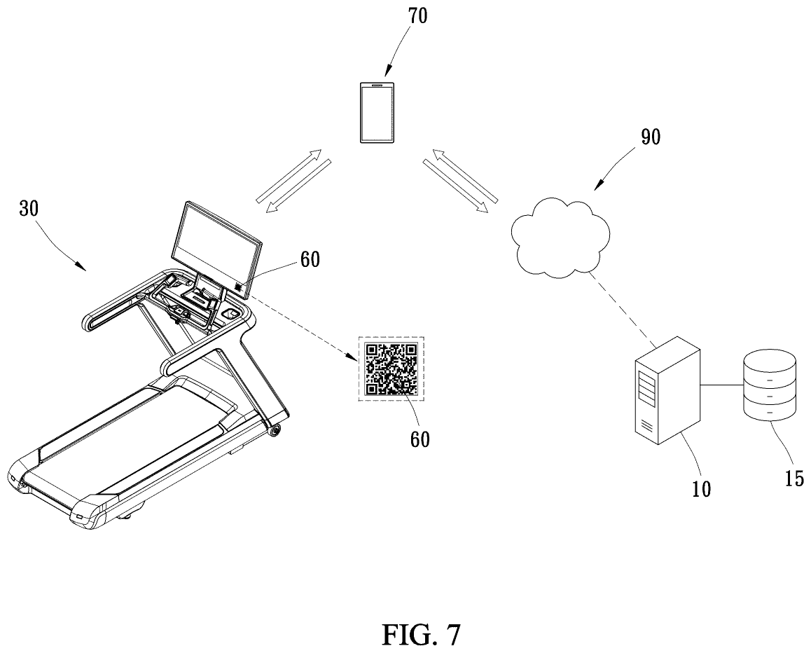

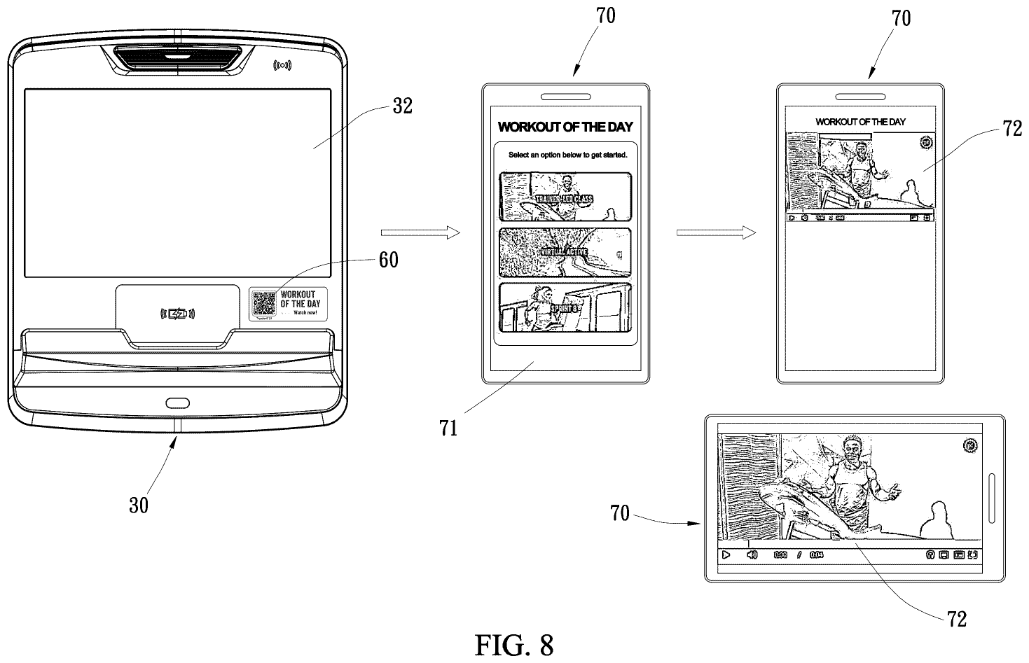

In another non-limiting example, each exercise machine 30 has an individual identifier 60 being accessible to the user, as shown in FIG. 7. Referring to FIG. 8, the identifier 60 is attached on the exercise machine 30 at an obvious location, for example, the identifier 60 may be attached on a console or a holder of the exercise machine 30. The identifier 60 is provided for allowing users to link to an online portal 71 (e.g., online storage access, a website or webpage such as a landing page) that facilitates access by one or more users to the media files 40 associated with the exercise machine 30 they are currently using from the file server 10 (e.g. the remote server or local server) through a computer network 90, which is able to access and manage data or files in a database 15. As mentioned before, the file server 10 can store and manage a plurality of media files 40. The identifier 60 may further be associated with the screening data related to the exercise machine, such as specifying the type of exercise machine or a specific “Workout of the Day” identifier to aid in the management of the plurality of media files 40. The file server 10 may manage a plurality of instances of the online portal 71 based on the type of exercise machine or another category and the identifier 60 is used to access a specific instance.

The online portal 71 can be controlled by the file server 10 to show the image representative of a recommended media file 72. In a non-limiting example, the recommended media file 72 is selected from the media files 40 stored in the file server 10 and updated every day to provide a daily workout or access to one or more workout programs for users to follow. Specifically, the identifier 60 of each exercise machine 30 is a machine-readable code, including a static or dynamic quick response (QR) code or a bar code that is specific to one type of exercise machines 30 that is used by the user so that the user can see the recommended media file 72 that is relevant to the exercise machine 30 they are on. For example, the user can view videos relevant to treadmills when they scan the QR code on the treadmill during their running workout. The QR code may be scannable by the user without having to turn on or directly interact with the exercise machine 30. For example, the QR code may be physically disposed on the exercise machine, or the QR code may be displayed on the display screen 50.

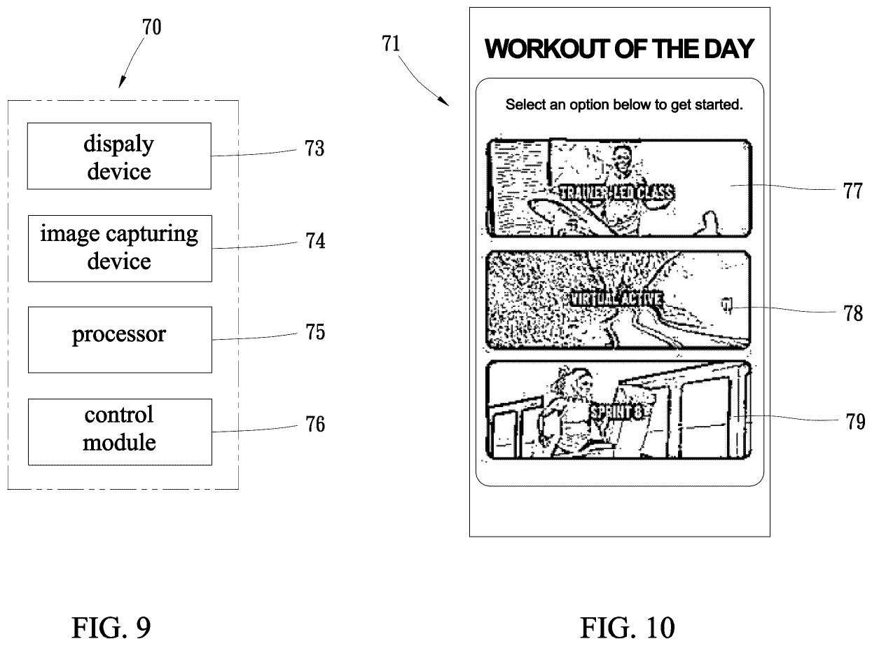

It is observed that more and more users are bringing their portable devices or user devices 70 (such as mobile phones or tablets) to the health club or other fitness facilities when they workout. From their portable device, they are listening to music, watching movies, keeping tabs on message threads, or doing trainer-led videos, even when they have access to content on the display screen of an exercise machine 30. With their own device, they do not need to log in and navigate on an unfamiliar device, or they do not need to connect their headphones to the console of the exercise machine 30 when they use their own device. The user device 70 is an electronic device portable by the user. The identifier 60 can be optically detectable by the user device 70 for user identification, so that the user is eligible to log in to the exercise machine 30 they are on. Referring to FIG. 9, the user device 70 comprises a display device 73, an image capture device 74 (e.g., a camera), a processor 75, and a control module 76 to allow the user to use the user device 70, such as a touchscreen. The user device 70 is operable to link to the online portal 71 to access the recommended media file 72 by scanning the identifier 60 through the image capturing device 74. The processor 75 of the user device 70 is configured to control the display device 73 to display the online portal 71 that shows the image representative of the recommended media file 72.

To provide a better user experience, each exercise machine 30 has a QR code 60 attached to it, allowing users to easily access the media files 40 associated with the corresponding exercise machine 30. It is well known that a user interface with the fewest clicks or number of steps, and the shortest period of time to access a result, will be the user's preferred experience. The QR code technology can be used to eliminate multiple steps for accessing the media files 40. Therefore, the user can use their user device 70 to obtain workout information or correlated video content by scanning the QR code 60 on the exercise machine 30 that they are ready to use. The entire process can be done in around 10 seconds.

It has been determined through experimentation that a guided workout will often result in a longer workout duration and at a higher average intensity. In one test, the exercise output on a treadmill for simply pressing “GO” (and not engaging with the media files 40) had an average workout duration between 12 to 16 minutes and an average speed between 3.5 to 4.5 mph. In contrast, users who engaged with the media files 40 had an average workout duration over 20 minutes and an average speed between 4.5 to 5.5 mph. Accordingly, the interaction of the user with the recommended media files may result in a higher quality workout. One reason active engagement may improve a user's workout is to provide additional motivation for the entirety of the guided workout session. With use of the recommended media files, and based on the data obtained by the inventors, a user likely experiences a higher workout duration and intensity due the recommended media file not having been seen before, which may make the experience feel new and engaging for the user.

A survey from a pilot program that tested the effectiveness of the guided workout also supports the idea that user interaction with the recommended files results in a higher quality workout. For example, of those who used the guided workout program: 75% reported reaching higher intensity levels due to the motivating instruction; 75% noticed that they were much more likely to finish their workouts; 88% said it felt easier to stay engaged in their workout; 75% found it easier to stay motivated for their workout; and 62.5% said they were more likely to visit the facility because of the virtual training options. Of those surveyed who did not use the guided workout program, 74% indicated that they would look for the virtual training content next time they used the cardio equipment at the facility. Accordingly, the system as a whole and delivery of recommended media files have a high likelihood of increasing the length and intensity of a user's workout, as well as a high likelihood of increasing workout frequency and the probability a user may engage with exercise machines that provide recommended media files. In addition to being fresh and unique, users tend to use and engage the recommended media files due to the speed and convenience by which the media files can be accessed.

However, the user experience may be negatively impacted by a behavioral element called “choice paralysis” when a user faces too many choices. For example, having 4000 or more videos available has its advantages, especially in a home setting. But in a commercial setting where the member often wants to get in and out of the facility quickly, having too many choices can interfere with the experience. Accordingly, the system of the present invention is programmed to provide the recommended media file 72, so that the user can perform the workout while using the exercise machine 30 by following the recommended media file 72.

Accordingly, the addition of the identifier 60 allows for a user to quickly access relevant, up-to-date, files with a personal device. In contrast, other methods to access recommended data often require a combination of manual filtering, a user login process, and/or additional data storage (e.g., a user profile). Therefore, the addition of an identifier 60 associated with an individual exercise machine 30 reduces the steps used determine a recommended media file and accordingly reduces the storage and computational requirements for the computational network.

For example, using the QR code 60, the online portal 71 may filter the relevant database 15, 25 for media files 40 relevant to the corresponding exercise machine 30. One example of filtering for the relevant media file 40 includes the online portal 71 removing reference to media files 40 directed to another exercise machine type. The online portal 71 may recommend at least one media file 40, or the recommended media files may already be stored separately in the database 15, 25 and the QR code 60 may be used to filter the recommended media files to be relevant to the corresponding exercise machine 30.

Referring to FIG. 10, the system limits the use option to three video categories 77, 78, 79. For example, when the user scans the QR code 60 on an exercise machine 30 to link to the online portal 71 (e.g. workout-of-the-day), the online portal 71 will display three categories for the user to choose from. These categories include: A first category 77 associated with an “instructor-led class” in which an instructor guides users to simulate their movements; a second category 78 associated with a “pre-recorded video” as a forward-motion video of outdoor reality; and a third category 79 associated with a “workout program”, such as a program of high intensity interval training. Other categories may be included in addition to or as a replacement of (or replacement of some of) the aforementioned three categories, such as a category of a “warm-up” program for users who only use the exercise machine to warm up; or a category of “first time use” for fitness beginners who have never used the exercise machine before. For example, when the user selects a category tile (e.g., instructor-led class), they will immediately go to the Workout-of-the-Day video for that category. When ready, the user then presses the start button to start the video and follows the instructor's instructions to adjust the load, speed, or elevation of the exercise machine. Similarly, if the user were to select a pre-recorded workout (e.g., a “workout program”), the user would follow the workout circuit and may have control over break times, set intensities, or other aspects of the workout.

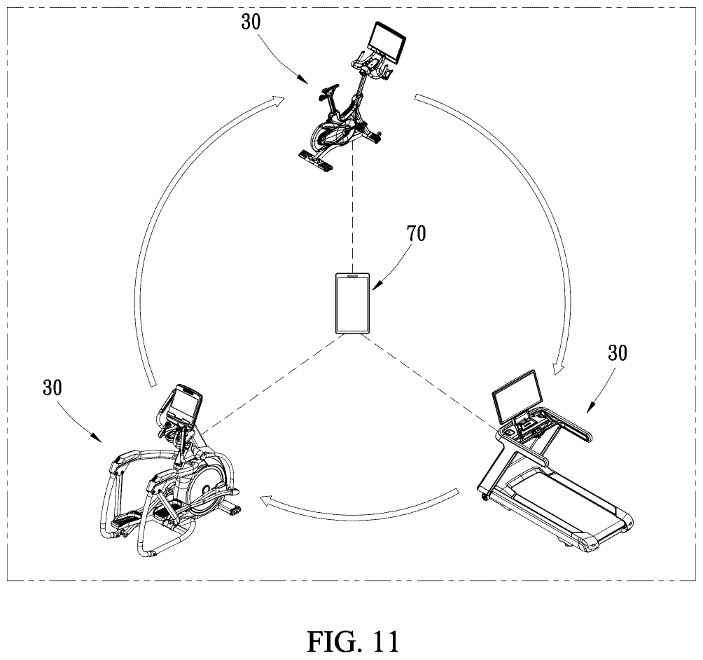

Referring to FIG. 11, the media file delivery system can provide a fresh workout every day to a circuit of strength or functional exercise machines. Many fitness clubs and facilities have training circuits there, and members move from one machine to another in sequence. Each workout station would have a device holder for the member's mobile phone or tablet, and the QR code would be mounted on or near the device holder. The system can be used to provide a themed circuit of workouts each day for exercise machines in the circuit. For example, there could be a “Core Strength” theme, and in the circuit, each correlated workout station would be controlled to show a core-strengthening videos. On another day, the theme could be “lower body” for legs and glutes (e.g., using the machines 30 as shown in FIG. 11), “upper body” for arms and chest, “endurance”, etc. Furthermore, the system has the option to offer three themes or categories on the online portal 71, so users could choose which theme they want that day. Accordingly, the file server 10 may provide a programmed workout to manage the recommended media files 72 for some exercise machines 30 in the workout place, which have the same theme in a workout circuit, so that the user can access the recommended media files 72 through the user device 70 from one exercise machine 30 to another exercise machine 30 in sequence for the programmed workout.

In one non-limiting example, the recommended media file 72 is randomly selected from the media files 40 stored in the file server 10 by a random generator. The recommended media file 72 is preferentially selected from the media files 40 that have never been selected or excludes the classes that were selected in the previous days. When one category is selected, the generator first checks the database 15 to see if a random class (or media file) has already been selected for that day, if it has, then that class is presented to the user. If a class has not been selected, the generator will select a random class to meet the criteria. An administrator may set specific criteria in the random generator. They can limit classes to a certain subtype, specific trainers, time lengths or based on other screening data. For example, the administrator could select to display classes that are a maximum of 31 minutes long. In one non-limiting example, the system uses a unique combination of features to deliver a new user experience, which includes having a limited quantity of distinct categories of content available to a user (instructor-led class, pre-recorded video, workout program), with a new recommended media file for each category. One advantage of using the random generator is that no human intervention or time is required to make updates available to the recommended media file each day. The process may be entirely automated.

Furthermore, the processor 75 of the user device 70 is operable to request the file server 10 to provide data of the recommended media file 72 through the computer network 90. When the user scans the identifier 60 on the exercise machine 30 and executes the recommended media file 72 on the online portal, the file server 10 will transmit the data of the recommended media file 72 to the user device 70 through the computer network 90 in a streaming manner according to the request of the processor 75, and the processor 75 will control the display device 73 to display the video content of the recommended media file 72 associated with the exercise machine 30.

In one example operation, the remote server 10 (the file server) is configured to host and accordingly control the online portal 71 through the computer network 90. The remote server 10 also has access to all the media files in the database 15. In some examples, the database 15 may be directly incorporated to the memory of the remote server 10. The online portal 71 is accessible by a user through the computer network through the identifier 60 corresponding to the exercise device 30. Specifically, a user device 70 gains access to the online portal 71 by scanning the identifier 60 on a corresponding exercise machine 30. The user device 70 may then send and receive data to the remote server 10 through the online portal 71 (which operates using computer network 90). One portion of data sent through the user device 70 to the file server 10 may include screening data such as the type of exercise machine scanned. The file server 10 may use the screening data corresponding to the scanned exercise machine to determine a recommend a media file 72 associated with the exercise machine from the media files stored on the database 15. In some examples, the remote server 10 may have pre-selected a plurality of recommended media files for each type of exercise machine and/or based on a theme or other criterion. The screening data may then be used to create a subset of the plurality of recommended media files that are relevant to the scanned identifier and the corresponding exercise device.

Once a recommended media file 72 is determined the remote server 10 may transmit an image representing the recommended media file (e.g., a thumbnail) to the user device through the online portal 71 without transmitting the video or audio associated with the media file. In some examples, the remote server 10 may recommend a plurality of media files. The user may select an image on the online portal 71 through the user device 70 and the online portal 71 would consequently communicate with the remote server and database 10 to stream the video and audio for the chosen media file.

It should be understood that one or more examples may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one example, the electronic-based aspects may be implemented in software (e.g., stored on non-transitory computer-readable medium) executable by one or more processing units, such as a microprocessor and/or application specific integrated circuits (“ASICs”). As such, a plurality of hardware and software-based devices, as well as a plurality of different structural components, may be utilized to implement the examples. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as performed by one component may be performed by multiple components in a distributed manner. Likewise, functionality performed by multiple components may be consolidated and performed by a single component. In some examples, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

### CLAUSES

Clause 1. A system for an exercise machine, the system comprising: a file server configured to store and manage media files within a database, each media file of the media files including one or more of video content, audio content, and an image representative of the media file, the file server further configured to control an online portal in communication with the database through a computer network; an exercise machine including a motion mechanism engageable or operable by a user to perform one or more physical exercises; an identifier associated with the exercise machine and including a connection to the online portal to facilitate user access to the media files; and a user device including a display, an image capture device, and a processor including instructions configured to communicate with the online portal by scanning the identifier via the image capture device for user access to the file server, the processor instructions further configured to control the display to illustrate the image representative of the media file, the user device configured to display at least one of the media files from the database via the display, wherein the file server is configured to: receive, via the user device through the online portal, screening data related to the exercise machine, access the media files stored in the database via the computer network, determine a recommended media file from the media files at least in part based on the screening data, and communicate at least a portion of the recommended media file to the user device through the online portal, and wherein the user device is configured to execute the recommended media file.

Clause 2. The system as claimed in clause 1, wherein the user device includes an electronic device portable by the user, and the identifier is optically detectable by the image capture device for user identification so that the user is eligible to access the online portal to retrieve the recommended media file provided by the file server.

Clause 3. The system as claimed in clause 1, wherein the identifier includes a machine-readable code on the exercise machine having a static or dynamic quick response (QR) code or bar code that is specific to one type of exercise machine that is used by the user so that the user can see the recommended media file that is relevant to the one type of exercise machine.

Clause 4. The system as claimed in clause 1, wherein the recommended media file is randomly selected from the media files stored in the file server based in part on whether the recommended media file has been previously selected.

Clause 5. The system as claimed in clause 1, wherein the processor includes instructions configured to request the file server provide data related to the recommended media file through the computer network, and wherein when the user scans the identifier on the exercise machine and executes the recommended media file on the online portal, the file server transmits the data of the recommended media file to the user device through the computer network in a streaming manner according to a request from the processor, and the processor controls the display to display the video content or the audio content, or both, of the recommended media file associated with the exercise machine.

Clause 6. The system as claimed in clause 1, wherein the online portal facilitates access by the user to the recommended media file or access to one or more workout programs.

Clause 7. The system as claimed in clause 1, wherein the online portal is controlled by the file server to display a specific quantity of categories for the user to choose from, and wherein one of the categories is associated with an instructor-led class in which an instructor guides users to simulate their movements.

Clause 8. The system as claimed in clause 1, wherein the online portal is controlled by the file server to display a first category of the media files associated with an instructor-led class in which an instructor guides users to simulate their movements, a second category of media files associated with a pre-recorded video as a forward-motion video of outdoor reality, and a third category of media files associated with a workout program.

Clause 9. A system for exercise machines, the system comprising: a file server configured to store and manage a plurality of media files, each media file of the plurality of media files including one or more of video content, audio content, and an image representative of the media file; a plurality of exercise machines, each having a motion mechanism operable by a user to perform physical exercises, each exercise machine having an identifier accessible to the user, the identifier provided to allow the user to link to an online portal that permits access by the user to the media files stored in the file server through a computer network, wherein the online portal is controlled by the file server to show an image representative of a recommended media file, the recommended media file selected from the media files stored in the file server and updated every day; and a user device including a display, an image capture device, and a processor, the user device operable to connect to the online portal by scanning the identifier through the image capture device, the processor including executable instructions to control the display to display the online portal that shows the image representative of the recommended media file; wherein the file server delivers a programmed workout to manage the recommended media files for two or more exercise machines of the plurality of exercise machines so that the user has access to the recommended media files through the user device from different exercise machines in sequence for the programmed workout.

Clause 10. The system as claimed in clause 9, wherein the user device includes an electronic device portable by the user, and the identifier of each exercise machine of the plurality of exercise machines is optically detectable by the user device for user identification so that the user is eligible to access the online portal and the recommended media file provided by the file server.

Clause 11. The system as claimed in clause 9, wherein the identifier of each exercise machine includes a machine-readable code having a static or dynamic quick response (QR) code or bar code specific to one type of exercise machine such that the user can see the recommended media file corresponding with the type of exercise machine.

Clause 12. The system as claimed in clause 9, wherein the recommended media file is randomly selected from the media files stored in the file server based in part on whether the recommended media file has been previously selected.

Clause 13. The system as claimed in clause 9, wherein the processor of the user device includes instructions to request the file server to provide data of the recommended media file through the computer network, and wherein when the user scans the identifier on the exercise machine and executes the recommended media file on the online portal, the file server transmits the data of the recommended media file to the user device through the computer network in a streaming manner according to the request of the processor, and wherein the processor will control the display device to display the video file of the recommended media file associated with the exercise machine.

Clause 14. The system as claimed in clause 9, wherein the online portal is controlled by the file server to display a specific quantity of categories for the user to choose from, and wherein one of the categories is associated with an instructor-led class in which an instructor guides users to simulate their movements.

Clause 15. The system as claimed in clause 9, wherein the online portal is controlled by the file server to display a first category of the media files associated with an instructor-led class in which an instructor guides users to simulate their movements, a second category of media files associated with a pre-recorded video as a forward-motion video of outdoor reality, and a third category of media files associated with a workout program.

Clause 16. A method of using an exercise machine, the method comprising: providing at least one file server to store and manage a plurality of media files within a database, each media file including video content, audio content, and an image representative of the media file, the file server configured to control one or more online portals in communication with the database; providing an identifier associated with an exercise machine, the identifier scannable by a user through a user device; accessing an online portal of the one or more online portals via a user device by scanning the identifier through an image capture device of the user device and displaying the online portal on a display of the user device, accessing the plurality of media files stored in the database; determining a recommended media file from the file server based on the identifier, the recommended media file selected from the media files stored in the file server and updated every day; communicating an image representative of the recommended media file through one online portal of the one or more portals to the display of the user device; accessing the recommended media file from the file server in response to the user instructing the file server to execute the recommended media file displayed on the one online portal; and communicating the recommended media file, including the video content, the audio content, or both, through the one online portal to the user device.

Clause 17. The method as claimed in clause 16, wherein the user device includes an electronic device portable by the user, and the identifier is optically detectable by the user device for user identification so that the user is eligible to login to the one online portal to access the recommended media file delivered by the file server.

Clause 18. The method as claimed in clause 16, wherein the identifier includes a machine-readable code on the exercise machine defined by a static or dynamic quick response (QR) code or a bar code specific to one type of exercise machine that is usable by the user so that the user can see the recommended media file that is relevant to the one type of exercise machine.

Clause 19. The method as claimed in clause 16, wherein the recommended media file is randomly selected from the media files stored in the file server based in part on whether the recommended media file has been previously selected.

Clause 20. The method as claimed in clause 16, wherein the online portal is controlled by the file server to display a first category of the media files associated with an instructor-led class in which an instructor guides users to simulate their movements, a second category of media files associated with a pre-recorded video as a forward-motion video of outdoor reality, and a third category of media files associated with a workout program.

1. A system for an exercise machine, the system comprising:
a file server configured to store and manage media files within a database, each media file of the media files including one or more of video content, audio content, and an image representative of the media file, the file server further configured to control an online portal in communication with the database through a computer network;
an exercise machine including a motion mechanism engageable or operable by a user to perform one or more physical exercises;
an identifier associated with the exercise machine and including a connection to the online portal to facilitate user access to the media files; and
a user device including a display, an image capture device, and a processor including instructions configured to communicate with the online portal by scanning the identifier via the image capture device for user access to the file server, the processor instructions further configured to control the display to illustrate the image representative of the media file, the user device configured to display at least one of the media files from the database via the display,
wherein the file server is configured to:
receive, via the user device through the online portal, screening data related to the exercise machine,
access the media files stored in the database via the computer network,
determine a recommended media file from the media files at least in part based on the screening data, and
communicate at least a portion of the recommended media file to the user device through the online portal, and
wherein the user device is configured to execute the recommended media file.

2. The system as claimed in claim 1, wherein the user device includes an electronic device portable by the user, and the identifier is optically detectable by the image capture device for user identification so that the user is eligible to access the online portal to retrieve the recommended media file provided by the file server.

3. The system as claimed in claim 1, wherein the identifier includes a machine-readable code on the exercise machine having a static or dynamic quick response (QR) code or bar code that is specific to one type of exercise machine that is used by the user so that the user can see the recommended media file that is relevant to the one type of exercise machine.

4. The system as claimed in claim 1, wherein the recommended media file is randomly selected from the media files stored in the file server based in part on whether the recommended media file has been previously selected.

5. The system as claimed in claim 1, wherein the processor includes instructions configured to request the file server provide data related to the recommended media file through the computer network, and wherein when the user scans the identifier on the exercise machine and executes the recommended media file on the online portal, the file server transmits the data of the recommended media file to the user device through the computer network in a streaming manner according to a request from the processor, and the processor controls the display to display the video content or the audio content, or both, of the recommended media file associated with the exercise machine.

6. The system as claimed in claim 1, wherein the online portal facilitates access by the user to the recommended media file or access to one or more workout programs.

7. The system as claimed in claim 1, wherein the online portal is controlled by the file server to display a specific quantity of categories for the user to choose from, and wherein one of the categories is associated with an instructor-led class in which an instructor guides users to simulate their movements.

8. The system as claimed in claim 1, wherein the online portal is controlled by the file server to display a first category of the media files associated with an instructor-led class in which an instructor guides users to simulate their movements, a second category of media files associated with a pre-recorded video as a forward-motion video of outdoor reality, and a third category of media files associated with a workout program.

9. A system for exercise machines, the system comprising:
a file server configured to store and manage a plurality of media files, each media file of the plurality of media files including one or more of video content, audio content, and an image representative of the media file;
a plurality of exercise machines, each having a motion mechanism operable by a user to perform physical exercises, each exercise machine having an identifier accessible to the user, the identifier provided to allow the user to link to an online portal that permits access by the user to the media files stored in the file server through a computer network, wherein the online portal is controlled by the file server to show an image representative of a recommended media file, the recommended media file selected from the media files stored in the file server and updated every day; and
a user device including a display, an image capture device, and a processor, the user device operable to connect to the online portal by scanning the identifier through the image capture device, the processor including executable instructions to control the display to display the online portal that shows the image representative of the recommended media file;
wherein the file server delivers a programmed workout to manage the recommended media files for two or more exercise machines of the plurality of exercise machines so that the user has access to the recommended media files through the user device from different exercise machines in sequence for the programmed workout.

10. The system as claimed in claim 9, wherein the user device includes an electronic device portable by the user, and the identifier of each exercise machine of the plurality of exercise machines is optically detectable by the user device for user identification so that the user is eligible to access the online portal and the recommended media file provided by the file server.

11. The system as claimed in claim 9, wherein the identifier of each exercise machine includes a machine-readable code having a static or dynamic quick response (QR) code or bar code specific to one type of exercise machine such that the user can see the recommended media file corresponding with the type of exercise machine.

12. The system as claimed in claim 9, wherein the recommended media file is randomly selected from the media files stored in the file server based in part on whether the recommended media file has been previously selected.

13. The system as claimed in claim 9, wherein the processor of the user device includes instructions to request the file server to provide data of the recommended media file through the computer network, and wherein when the user scans the identifier on the exercise machine and executes the recommended media file on the online portal, the file server transmits the data of the recommended media file to the user device through the computer network in a streaming manner according to the request of the processor, and wherein the processor will control the display device to display the video file of the recommended media file associated with the exercise machine.

14. The system as claimed in claim 9, wherein the online portal is controlled by the file server to display a specific quantity of categories for the user to choose from, and wherein one of the categories is associated with an instructor-led class in which an instructor guides users to simulate their movements.

15. The system as claimed in claim 9, wherein the online portal is controlled by the file server to display a first category of the media files associated with an instructor-led class in which an instructor guides users to simulate their movements, a second category of media files associated with a pre-recorded video as a forward-motion video of outdoor reality, and a third category of media files associated with a workout program.

16. A method of using an exercise machine, the method comprising:
providing at least one file server to store and manage a plurality of media files within a database, each media file including video content, audio content, and an image representative of the media file, the file server configured to control one or more online portals in communication with the database;
providing an identifier associated with an exercise machine, the identifier scannable by a user through a user device;
accessing an online portal of the one or more online portals via a user device by scanning the identifier through an image capture device of the user device and displaying the online portal on a display of the user device,
accessing the plurality of media files stored in the database;
determining a recommended media file from the file server based on the identifier, the recommended media file selected from the media files stored in the file server and updated every day;
communicating an image representative of the recommended media file through one online portal of the one or more portals to the display of the user device;
accessing the recommended media file from the file server in response to the user instructing the file server to execute the recommended media file displayed on the one online portal; and
communicating the recommended media file, including the video content, the audio content, or both, through the one online portal to the user device.

17. The method as claimed in claim 16, wherein the user device includes an electronic device portable by the user, and the identifier is optically detectable by the user device for user identification so that the user is eligible to login to the one online portal to access the recommended media file delivered by the file server.

18. The method as claimed in claim 16, wherein the identifier includes a machine-readable code on the exercise machine defined by a static or dynamic quick response (QR) code or a bar code specific to one type of exercise machine that is usable by the user so that the user can see the recommended media file that is relevant to the one type of exercise machine.

19. The method as claimed in claim 16, wherein the recommended media file is randomly selected from the media files stored in the file server based in part on whether the recommended media file has been previously selected.

20. The method as claimed in claim 16, wherein the online portal is controlled by the file server to display a first category of the media files associated with an instructor-led class in which an instructor guides users to simulate their movements, a second category of media files associated with a pre-recorded video as a forward-motion video of outdoor reality, and a third category of media files associated with a workout program.
